(19) United States
(12) Patent Application Publication
(10) Pub. No.: US 2013/0268430 A1
(43) Pub. Date: Oct. 10, 2013

(54) METHOD AND APPARATUS FOR DYNAMIC GIFT CARD PROCESSING

(71) Applicants: RICKY A. LOPEZ, San Diego, CA (US); PAUL BUSS, San Diego, CA (US)

(72) Inventors: Ricky A. Lopez, San Diego, CA (US); Paul Buss, San Diego, CA (US)

(73) Assignee: Ziftit, Inc., San Diego, CA (US)

(21) Appl. No.: 13/827,252

(22) Filed: Mar. 14, 2013

Related U.S. Application Data
(60) Provisional application No. 61/620,908, filed on Apr. 5, 2012.

(51) Int. Cl. G06Q 20/34

(52) U.S. Cl. CPC G06Q 20/3433
USPC 705/39

(57) ABSTRACT

A methods and apparatus for dynamic gift card processing are disclosed. In a computer-implemented method, a list of one or more products requested by a first party is displayed. At least one payment is received from at least one funding party for at least a portion of one or more of the products. The received payment(s) are stored at an account. A first request is received for the first party to utilize funds from the account for a purchase of one of the products. A gift card is issued to the first party for a first amount of funds. The first amount may be an amount specified by the first party, or the first amount may be the lesser of a remaining balance for the purchase of said one product by the first party, and a second, predetermined, amount of funds.

### PRIORITY CLAIM

This application claims priority from U.S. Provisional Pat. App. Ser. No. 61/620,908 entitled “Non-Reloadable Open Loop, Discount and Regular Closed Loop Gift Card Processing” filed Apr. 5, 2012, which is hereby incorporated by reference herein in its entirety.

### FIELD

Aspects of the present disclosure relate in general to payment systems. In particular, aspects of the disclosure include dynamic gift card processing, which may include non-reloadable open loop, discount and regular closed loop gift card processing for virtual and/or physical gift cards.

### BACKGROUND

A gift card is a restricted monetary equivalent or scrip that is issued by retailers or banks to be used as an alternative to a non-monetary gift. A gift card may also be referred to as a “stored value card.”

Gift cards rank as the second-most given gift by consumers in the United States (2006) and the most-wanted gift by women, and the third-most-wanted gift by males. In Canada, $1.8 billion were spent on gift cards and in the UK, it is estimated that £3 billion were spent in 2009 whereas in the United States, about $80 billion were paid for gift cards in 2006. The recipients of a gift card can use it at their discretion within the restrictions set by the issuing agency.

The first gift card using a payments infrastructure was introduced by Blockbuster Entertainment in the fall of 1994 in Ft. Lauderdale, Fla. Initially, the Blockbuster gift card was to replace gift certificates that were being counterfeited with color copiers and color printers. It was this over redemption of gift cards that launched the search for an alternative. The first gift card transactions were processed by what was then, Nabanco of Sunrise, Fla. Nabanco was the developer of the first platform for the processing of gift cards using existing payment infrastructure. Blockbuster was later followed by a card by Neiman Marcus, and the Mobil Oil gas card which initially offered prepaid phone value provided by MCI.

### SUMMARY

In some embodiments of the present disclosure corresponding to a computer-implemented method, a list of one or more products requested by a first party is displayed. At least one payment is received from at least one funding party for at least a portion of one or more of the products, wherein the payment is on behalf of the first party. The received payment(s) is stored at an account. A first request is received for the first party to utilize funds from the account for a purchase of one of the products. A virtual or physical gift card is issued to the first party for a first amount of funds.

In some embodiments of the present disclosure corresponding to a computer-implemented method, a list of one or more gifts requested by a first party is displayed. A contribution level for each gift, based on one or more contributions previously made by one or more funding parties towards said gift, is displayed. An indication of a fully funded gift among said one or more gifts is displayed. A first input is received from the first party. The first input is configured to initiate a purchase of the fully funded gift. A second input is received from the first party. The second input is configured to initiate issuance of a gift card to the first party for a first amount of funds. Issuance of the gift card to the first party is initiated for the first amount of funds.

In some embodiments, a computer-readable storage medium is encoded with data and instructions, that when executed by a computing device, causes the computing device to perform the computer-implemented methods discussed above.

### BRIEF DESCRIPTION OF THE DRAWINGS

The following will be apparent from elements of the figures, which are provided for illustrative purposes and are not necessarily to scale.

FIG. 1 is a block diagram of a system for processing dynamically generated gift cards in accordance with some embodiments of the present disclosure.

FIG. 2 illustrates a computing device capable of processing dynamically generated gift cards in accordance with some embodiments.

FIG. 3 elaborates on a gift card server in accordance with some embodiments.

FIGS. 4A-4G are depictions of example screenshots displayed to a giftee in accordance with some embodiments.

FIG. 5 is an illustration of contributions by various entities towards a user's gift goals in accordance with some embodiments.

FIG. 6 is a flow diagram of account processing to support dynamic gift cards in accordance with some embodiments.

FIG. 7 is a flow diagram of a process in accordance with some embodiments.

FIG. 8 is a flow diagram of another process in accordance with some embodiments.

### DETAILED DESCRIPTION

This description of the exemplary embodiments is intended to be read in connection with the accompanying drawings, which are to be considered part of the entire written description.

In various embodiments, virtual gift cards (e.g., electronically processed, without the user ever receiving a physical card) are provided, and in some embodiments physical gift cards are provided either in addition to or in lieu of virtual gift cards. Virtual non-reloadable open loop and closed loop gift cards may be used instead of reloadable open loop gift cards. Reloadable gift cards may also be used. Closed loop gift cards are typically usable at a limited range of venues, e.g., at one of the stores of a particular retailer from whom such a card is purchased. In contrast, open loop gift cards are backed by a card network and may be used at any participating merchant within the network, providing a larger number of locations at which such a card may be used.

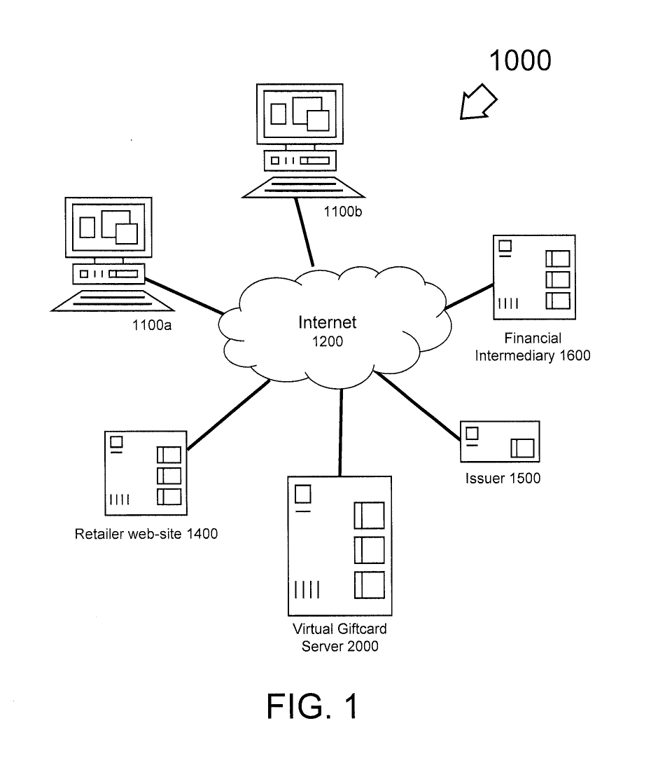

FIG. 1 is a block diagram of a system for processing dynamic gift cards in accordance with some embodiments of the present disclosure. Various nodes are connected to one another by a network, which may be Internet 1200. Computers 1100a, 1100b (generally computers 1100) are utilized by users to access (via Internet 1200) a website 1400 of a merchant such as a retailer of any type of product wherein the merchant is configured to accept transactions made with the dynamic gift card system disclosed herein. As part of an e-commerce transaction on website 1400, the user (e.g., Sally) may be presented with a screen that lists payment options (e.g., pay by credit card, which credit card, etc.). In some embodiments, a virtual gift card is dynamically generated (e.g., instantiated) based on the circumstances of the product being purchased, as described in greater detail below. Unlike traditional static gift cards that are either offered at a retailer's store for a predetermined amount or offered at no charge and then loaded with funds by the person who thus acquired the gift card, gift cards in various embodiments of the present disclosure are created in a secure manner that draws on funds provided by one or more contributors (gifters) and in a dynamic manner that that is keyed to a particular transaction being attempted by a recipient of such contribution(s) (giftee). A virtual gift card server 2000 coordinates such dynamic gift card processing. A financial intermediary 1600 controls the movement of funds across various accounts (described further below), and an issuer (e.g., a bank or any card issuing entity) issues a virtual or physical gift card that is dynamically generated.

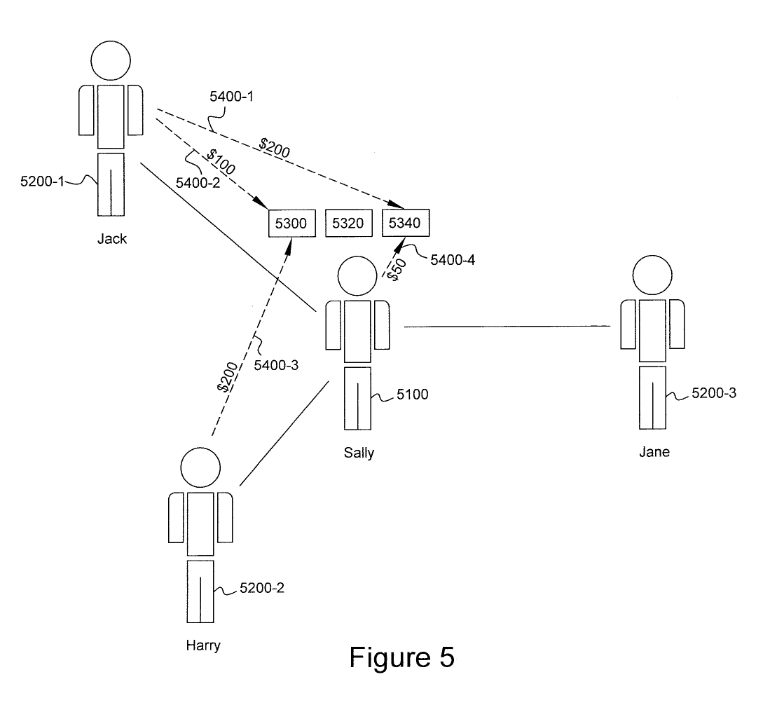

In some embodiments, a dynamically generated gift card may utilize funds originated from a contributing community. Referring to FIG. 5, a user 5100 (e.g., Sally) who wants to buy a particular product (which may be any good, such as a jacket, or any service, such as a trip to a destination) provides an indication to gift card server 2000 regarding the desired product. At this stage, Sally is not yet in the process of buying the product but is merely indicating her desire. Specifically, by making her interest known, in some embodiments other entities (e.g., friends, associates, or acquaintances of Sally, or generally any other person, institution, corporation, or the like) are enabled to help Sally toward her goal by contributing some amount toward the requested product (or by purchasing it outright). In the example shown in FIG. 5, three other people 5200-1 (e.g., Jack), 5200-2 (e.g., Harry), and 5200-3 (e.g., Jane) are linked to Sally (e.g., via a social network or a gift network) and can help Sally achieve her goals (i.e., they can “gift” her contributions towards products she desires). These people 5200-1, 5200-2, and 5200-3 do not necessarily have to be “friends” or first-degree-connections of Sally in the sense of any particular social network but merely are people who are configured (e.g., by gift card server 2000) to make contributions towards Sally's desired products. A registration or enrollment process may occur initially to configure Jack to be able to contribute to Sally's goals in this way, and similar processes may occur regarding Harry and Jane.

In FIG. 5, accounts 5300, 5320, and 5340 correspond to contributions that may be made towards a first gift (i.e., first desired product, such as a jacket), a second gift (e.g., a stereo), and a third gift (e.g., airline tickets to Italy), for example. In some embodiments, accounts 5300, 5320, and 5340 all correspond to the same pool of funds contributed to Sally (there do not have to be separate bank accounts), and the amount that is contributed toward each individual item is tracked and thus distinguishes the different accounts. Whereas with traditional gift registries a person such as Sally makes her requests known and others purchase entire gifts for her, in embodiments of the present disclosure a friend of Sally's (e.g., Jack) may contribute just a portion of the full amount for the requested product, e.g., by contributing $200 towards airline tickets (as shown by dashed arrow 5400-1) that cost $1000 or by contributing $100 towards a jacket that costs $300 (as shown by dashed arrow 5400-2). Similarly, Harry is shown by dashed arrow 5400-3 contributing $200 towards the jacket. In this example, Jane has not yet contributed towards any of Sally's desired products but may have initiated a gift relationship with Sally (e.g., signed up to be informed of Sally's desired products) such that Jane can subsequently make a contribution. Sally may contribute towards her own goals, such as $50 towards the airline tickets as shown by dashed arrow $5400-4. It is understood that any number of desired products and any number of contributors may be present, and each contributor may contribute any amount towards any one or more of the desired products. Contributors (e.g., 5200-1, 5200-2, 5200-3) may themselves have their own desired products for which others (including Sally or other people) make contributions.

Thus, contributors can advantageously contribute any desired amount of funds and are not constrained to paying the full amount of a desired gift as in some conventional gifting approaches (e.g., conventional gift registries). For example, if all the items on Sally's gift list cost $100 or more, an individual Tom who has only $5 (for example) available to contribute can still make a contribution that helps Sally achieve her goals. Also, multiple people can advantageously make contributions towards the same gift, thus effectively cumulatively gifting an item with any desired proportions of relative proportions, unlike with prior approaches.

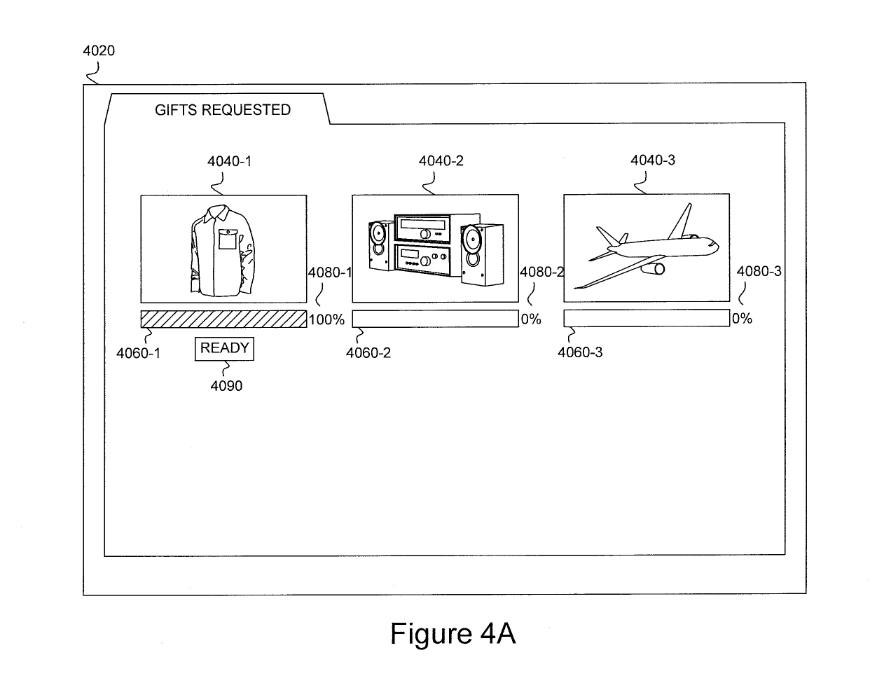

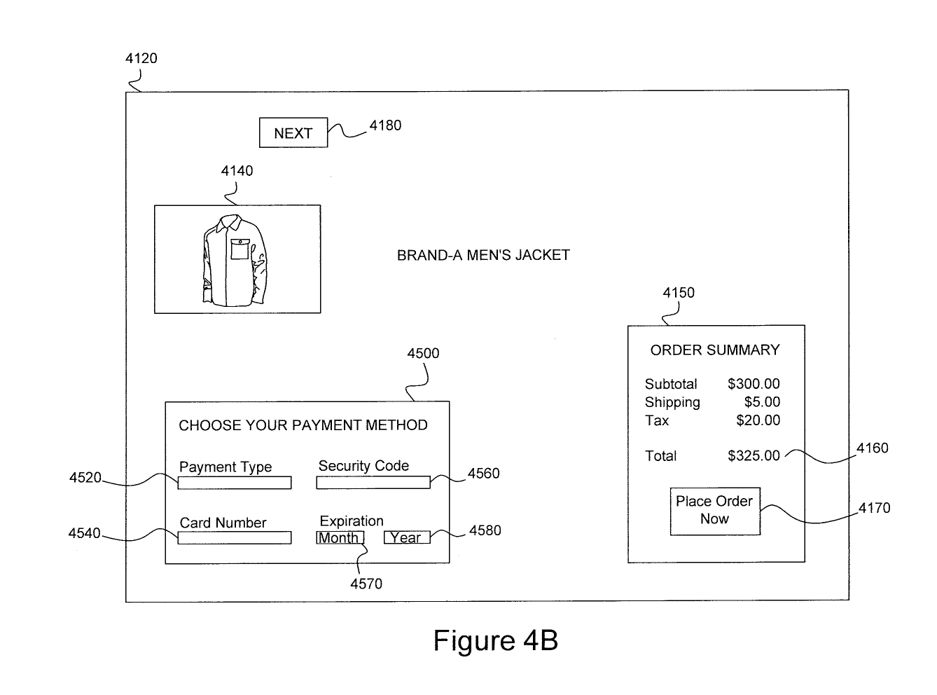

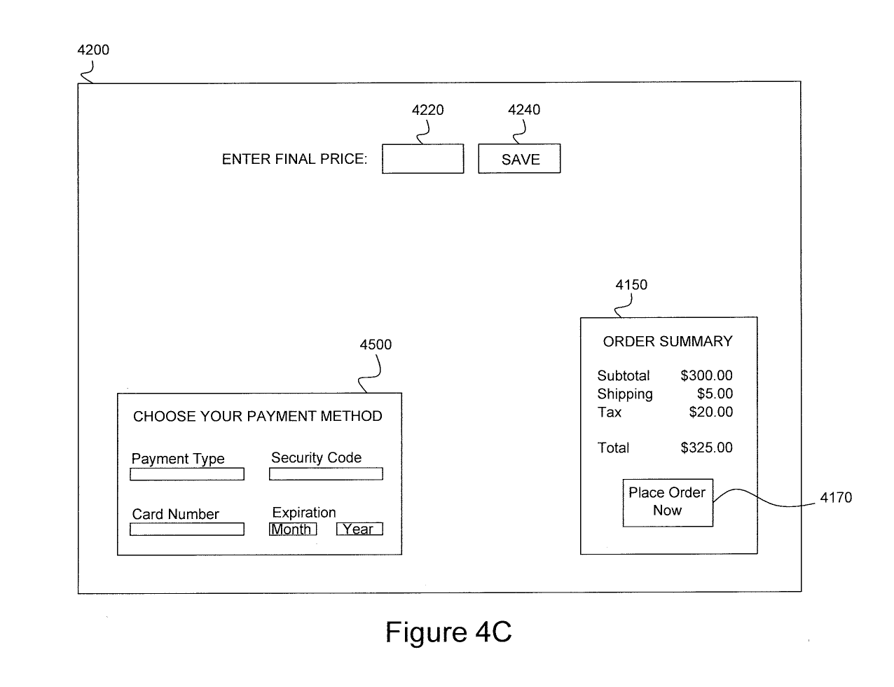

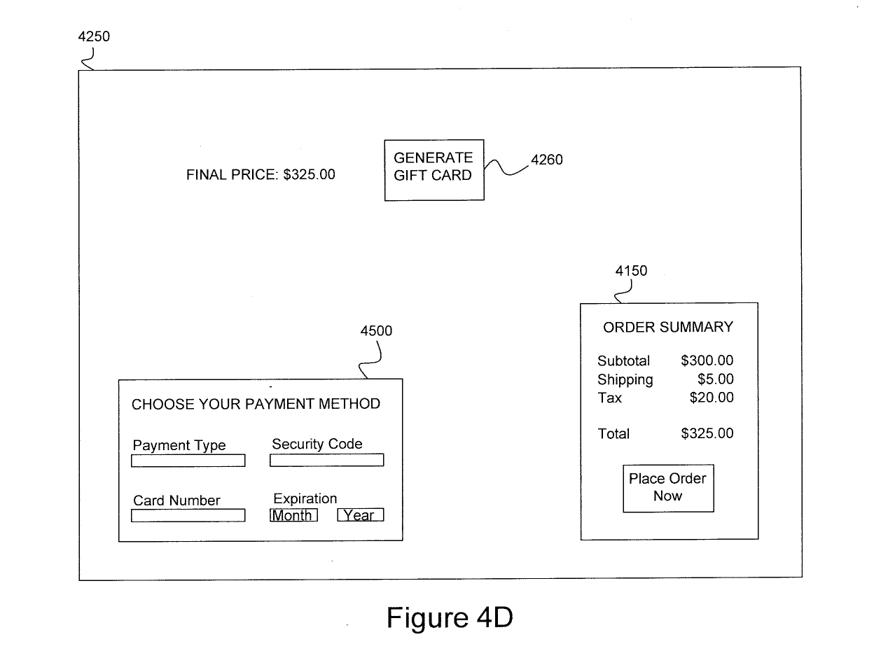

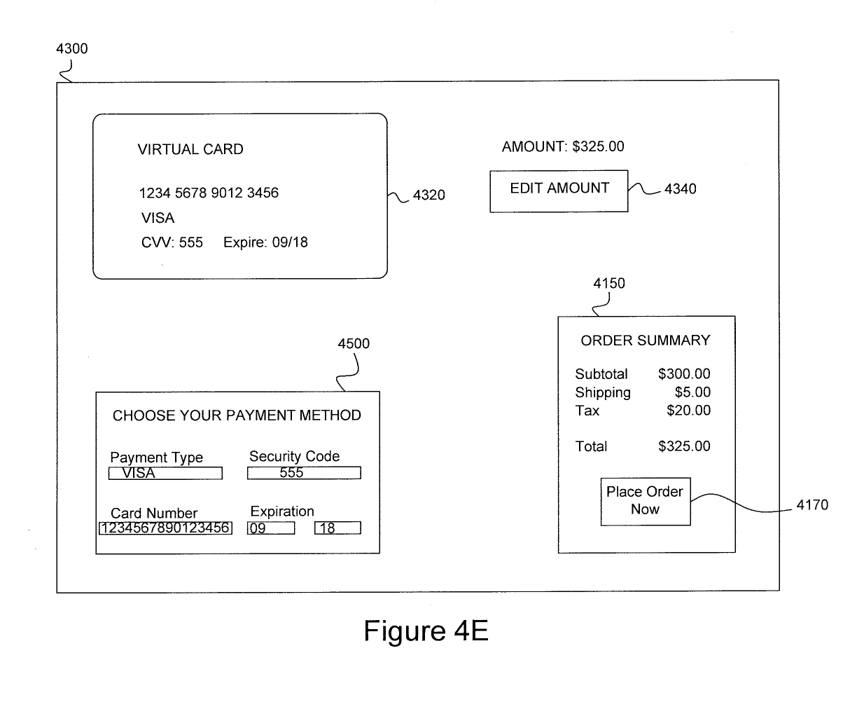

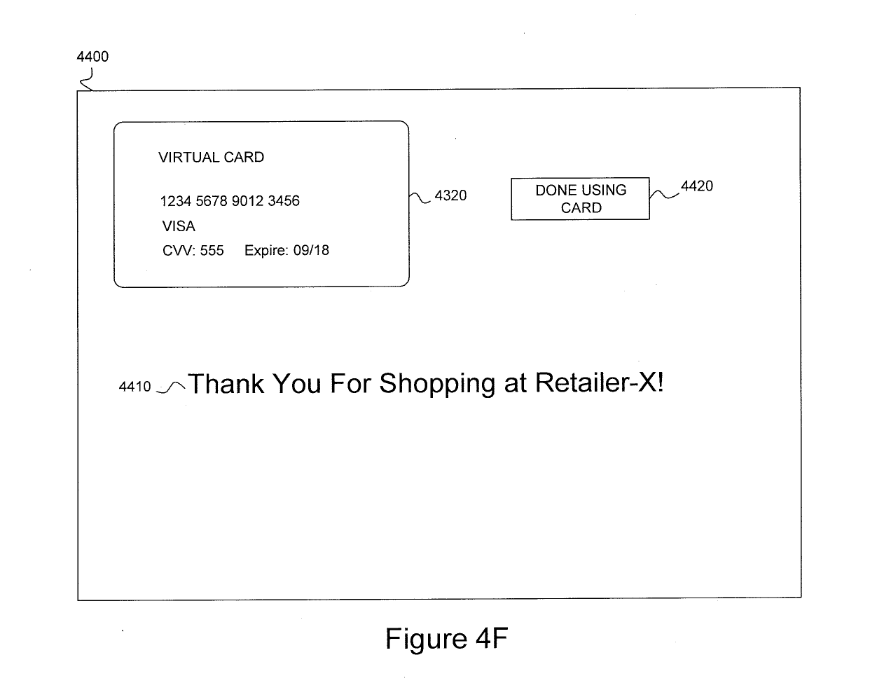

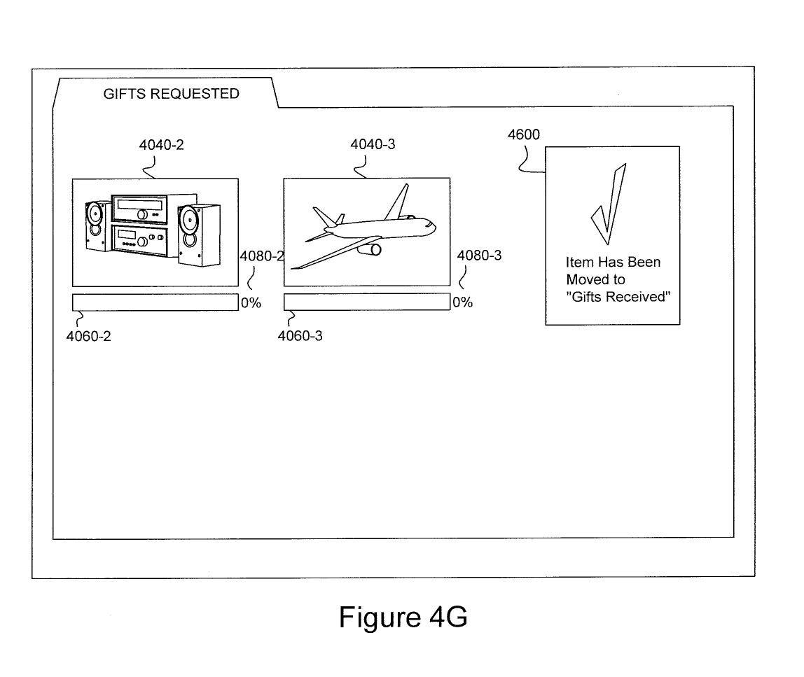

Various screenshots that may be presented to a giftee (e.g., Sally) are depicted in FIGS. 4A-4G. FIG. 4A depicts an example screenshot 4020 of a “Gifts Requested” display in which Sally can view the status of various desired products (desired gifts) and the current contribution levels attained towards such gifts. A personal information display 4100 may show Sally's In this example (which is different from the example of FIG. 5), Sally can see the relative contribution status for her requested jacket 4040-1, stereo 4040-2, and airline tickets 4040-3 (generally “gifts 4040” or “icons “4040”). Beneath each icon 4040-i, a progress bar 4060-i or other visual indicator may be displayed to indicate to Sally the current contribution level toward that gift (how much of the total price has been contributed so far). In this example (unlike the example of FIG. 5), the jacket has been fully funded by contributors, but no contributions have been received towards the stereo or airline tickets. Progress bar 4060-1 is entirely filled for gift 4040, and progress bars 4060-2 and 4060-3 are empty, corresponding to no contributions as of yet towards gifts 4040-2 and 4040-3, respectively. In some embodiments, in addition to or instead of progress bars 4060, a numerical display 4080 indicates the contribution status. In this example, A contribution level of 100% is visible at display 4080-1, and 0% is visible at displays 4080-2 and 4080-3.

In some embodiments, when a particular gift 4040 is fully funded (i.e., sufficient contributions have been received from one or more contributors to fully fund the gift), a visual indicator (e.g., button) 4090 is displayed. The indicator may be clicked or activated in any other way to initiate a process of obtaining the gift for Sally. No specific type of button is needed, and other selection mechanisms are contemplated as well. For example, in some embodiments the giftee may simply click on icon 4040-1, enter a code corresponding to gift 4040-1, or in any other way select the fully funded gift 4040-1.

When the giftee Sally thus selects the fully funded gift 4040-1, Sally may be directed to a product detail page at the retailer's website. Sally may proceed to the retailer's usual online checkout process, which may show the item 4140 and may show the price of the item at an order summary display region 4150. An example screenshot of this stage of the checkout process is depicted as display 4120 in FIG. 4B. For example, the base price ($300.00 in this example), shipping, tax, and total price are displayed. In this example, a total price of $325.00 is displayed at 4160. A payment options display region 4500 is shown in FIG. 4B. Region 4500 includes input areas 4520 for credit card type (e.g., Credit-Card-X), 4540 for card number, 4560 for card verification value (CVV) (also known as security code), and 4570 and 4580 for month and year of expiration. Whereas with conventional checkout processes the user would then activate a button 4170 labeled “Place Order Now” (or equivalent), in accordance with some embodiments Sally instead activates a button 4180 (labeled “Next” or another label) to continue with dynamic gift card generation.

FIG. 4C is a depiction of an example screenshot of the next stage in the processing. In display 4200, the user (Sally) is prompted for the final price at field 4220. Requiring the user to enter the exact amount may promote security, e.g., by ensuring that the user did indeed consent to generation of a gift card corresponding to that amount, or by ensuring that only that amount (as opposed to a higher amount which might correspond to the user's full balance) can be spent. Sally may then click a button 4240 labeled “Save” (or another label). In some embodiments, the user is then permitted to edit the amount. A maximum limit on the number of such edits may be instituted.

Sally may then be presented with a screen such as the screenshot depicted in FIG. 4D. In display 4250, a button 4260 (or another input selection mechanism) labeled “Generate Gift Card (or another label) may be activated to generate a virtual gift card. When Sally is ready to submit the information on the retailer's website, she activates button 4260.

A display 4320 of a virtual card may then be presented to Sally (see FIG. 4E). In display 4300, the display 4320 of the virtual card shows the card type (e.g., Visa), card number, card verification value, and expiration date. Then, Sally fills in the corresponding fields of payment method display 4500 using this virtual card, as shown in FIG. 4E. Sally may then click the “Place Order Now” button 417.

Referring to FIG. 4F, at a next screen 4400, a message 4410 may be displayed acknowledging receipt of the order. Sally may then activate a button 4420 labeled “Done Using Card” (or another label). When the user closes the retailer's checkout screen and returns to the “Gifts Requested Display” (see FIG. 4G), icon 4600 indicates that the product (in this case, the jacket) has been purchased and has been moved to a “Gifts Received” display that Sally may view.

Thus, a virtual card may be generated dynamically based on the purchasing scenario (e.g., the amount needed for a particular product being purchased). In some embodiments, the virtual gift card is used for only a portion of a purchase instead of for the entire purchased product. For example, one or more available discount closed loop gift cards may be displayed, and Sally can select them. Additionally or alternatively, Sally may use a gift certificate or other payment option for a portion of the payment. When the remaining balance (after these other payment options are taken into consideration) is displayed on the retailer's page, Sally may then input that remaining balance as the exact amount into the virtual non-reloadable gift card section and generate a virtual gift card for the exact remaining balance.

In some embodiments, users may be given the option of requesting a physical non reloadable gift card in addition to the virtual gift card. In some embodiments, the physical non-reloadable gift card may be sent in lieu of the virtual gift card. Such a physical open loop gift card may be carried by the user to a merchant within the network corresponding to the open loop gift card and may be used like an ordinary credit or debit card.

In some embodiments, instead of the user being prompted to enter a final price (the exact amount described above), the new gift card is automatically loaded with the lesser of: (a) the user's full balance; and (b) a fixed, predetermined amount (e.g., $3500, or any other amount of funds). In other words, the amount that will be loaded on the card is computed as min(X, Y), where min specifies the function that computes the minimum of its two arguments, X is the user's full balance, and Y is the fixed, predetermined amount. In some embodiments the default amount to be loaded is min(X, Y) and the user is provided the option to override that with any specified (manually entered) amount, which may be capped (limited) by Y in some embodiments, e.g., if the issuing bank places a restriction on the maximum amount that can be loaded onto a card.

In some embodiments, rather than issuing (generating) a new gift card for each purchase, gift cards are maintained active for a predetermined duration (e.g., 24 hours, or any other time period). When the gift card is active (non-expired), the user (e.g., Sally) can make as many purchases as she wants using the gift card, for any of the gifts that she requested and for which contributions have been made (e.g., by others or by her). Thus, after the first product is purchased, the existing gift card will be displayed for subsequent purchases, assuming the gift card is still active and still has a nonzero balance. The contributed funds are thus redeemable for any product (e.g., any requested gift) while the gift card is active, regardless of which product the contributor (gifter) initially intended to contribute funds towards. For example, Suppose Sally's mother gifted $100 towards a textbook for Sally. In some embodiments, during the active (non-expired) period of an issued gift card, Sally may use the gift card for any product she requested, e.g., a motorcycle, subject to the remaining balance of the gift card. Because in this example the contributed funds are stored in a single account that does not segregated funds according to particular items, the entire pool of funds in that account can be drawn upon (via the gift card) for Sally's purchase of any requested item, providing flexibility to Sally.

In some embodiments, at or after the expiration time for the gift card, any remaining balance on the gift card is returned to the user's account (e.g., non-card account 6200, discussed below). By automatically returning the remaining gift card balance so that the user may subsequently avail herself of those funds, funds are not wasted from the user's perspective. The next time the user requests a purchase of a product for which contributions have been made, a new gift card is issued.

In some embodiments, the user selects on a per-item (per-product) basis which products she wants to obtain via redemption of previously contributed funds. In other embodiments, she selects multiple products and a single gift card is generated for the products.

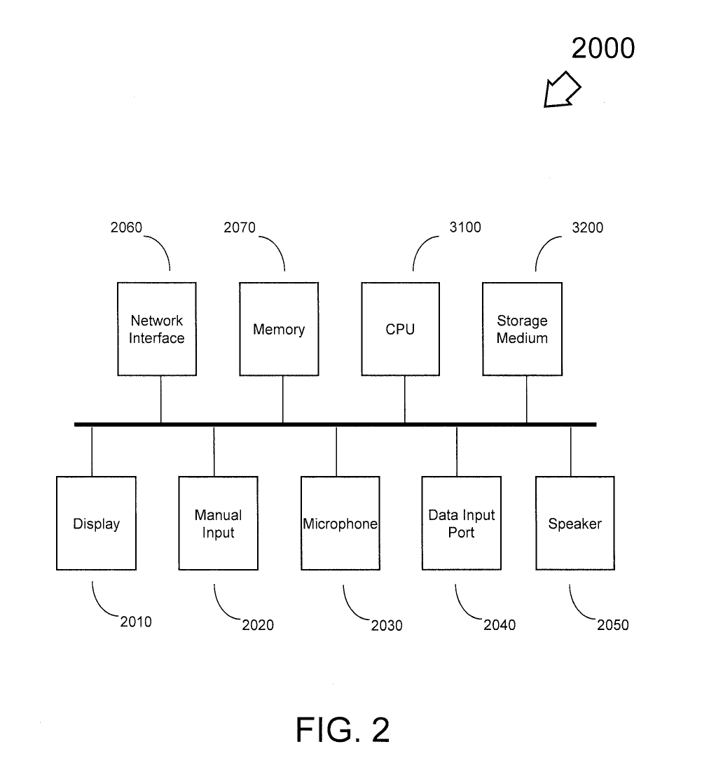

FIG. 2 illustrates a computing device capable of processing dynamically generated gift cards in accordance with some embodiments. Gift card server 2000 comprises a processor 3100, memory 2070, storage medium 3200, and network interface 2060. Gift card server 2000 may also contain one or more of the following: display 2010, manual input 2020, microphone 2030, data input port 2040, and speaker 2050.

Gift card server 2000 may run a multi-tasking operating system (OS) and include at least one processor or central processing unit (CPU) 3100. Processor 3100 may be any central processing unit, microprocessor, micro-controller, computational device or circuit known in the art.

Memory 2070 may be any memory (e.g., random access memory) known in the art.

Display 2010 may be a visual display such as a cathode ray tube (CRT) monitor, a liquid crystal display (LCD) screen, plasma display, projector, organic light emitting diode (OLED) display, touch-sensitive screen, or other monitors as are known in the art for visually displaying images, graphics and/or text to a user.

Manual input device 2020 may be a conventional keyboard, keypad, mouse, trackball, or other input device as is known in the art for the manual input of data.

Data input port 2040 may be any data port as is known in the art for interfacing with a user, such as a telephone, instant messaging, World-Wide-Web, or electronic-mail interface. In some embodiments, data input port 2040 is an external accessory using a data protocol such as RS-232, Universal Serial Bus (USB), or Institute of Electrical and Electronics Engineers (IEEE) Standard No. 1394 (‘Firewire’).

Network interface 2060 may be any data port as is known in the art for interfacing, communicating or transferring data across a computer network, with examples of such networks including Transmission Control Protocol/Internet Protocol (TCP/IP), Ethernet, Fiber Distributed Data Interface (FDDI), token bus, or token ring networks. Network interface 2060 allows gift card server 2000 to communicate with other nodes as shown in FIG. 1.

Computer-readable storage medium 3200 may be a conventional read/write memory such as a magnetic disk drive, floppy disk drive, compact-disk read-only-memory (CD-ROM) drive, digital versatile disk (DVD) drive, high definition digital versatile disk (HD-DVD) drive, magneto-optical drive, optical drive, flash memory, memory stick, non-volatile transistor-based memory or other computer-readable memory device as is known in the art for storing and retrieving data. Significantly, computer-readable storage medium 3200 may be remotely located from processor 3100, and be connected to processor 3100 via a network such as a local area network (LAN), a wide area network (WAN), or the Internet.

Computers 1100 that are used by a user may also have the components shown in FIG. 2. For example, a user (e.g., Sally) may use any type of computing device 1100a (e.g., desktop computer, laptop computer, tablet computer, smartphone, etc.) having a processor, memory, storage medium and network interface to access the website 1400 of a retailer.

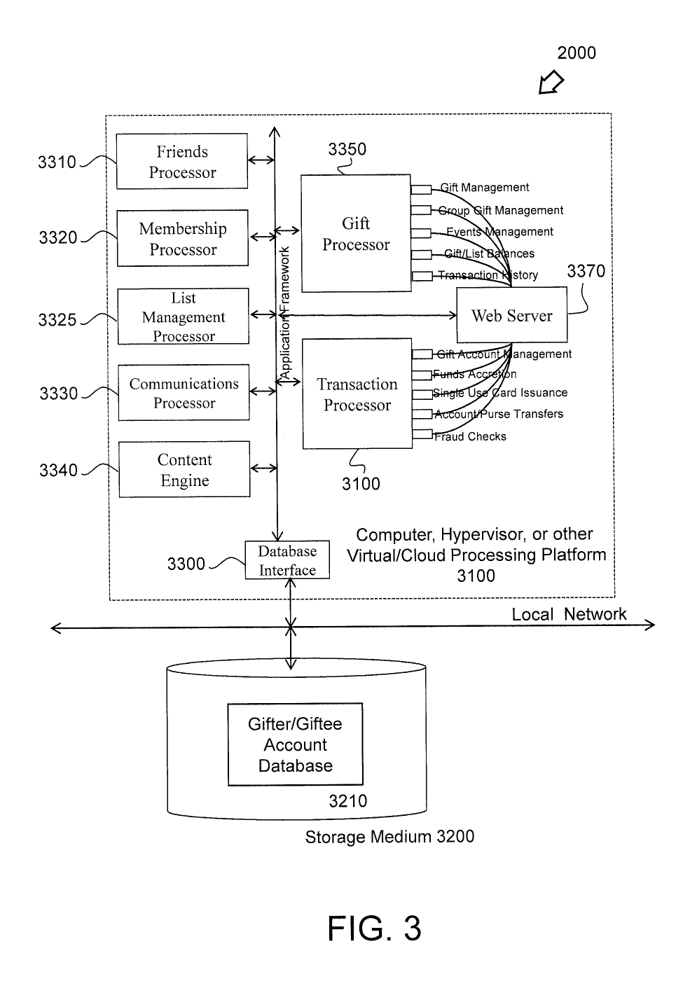

FIG. 3 elaborates on gift card server 2000 in accordance with some embodiments. Storage medium 3200 may include a database 3210 that stores accounts containing information regarding giftees (persons desiring contributions) and gifters (contributors who provide funds to benefit such giftees). Storage medium 3200 may communicate (e.g., via a network or bus) with other components that may be implemented on a computer, hypervisor, or other virtual/cloud processing platform 3100 (e.g., to provide services to a user via a web application in a cloud computing implementation of various embodiments) (for convenience, referred to herein as processing platform 3100).

Processing platform 3100 may have components shown in FIG. 2 such as a network interface, CPU, and memory. Referring again to FIG. 3, processing platform 3100 includes a database interface 3300 for interfacing with database 3210. Processing platform 3100 also includes a web server 3370 and various processing modules, including a friends processing module 3310, a membership processing module 3320, a list management processing module 3325, a communications processing module 3330, a content engine 3340, a gift processing module 3350, and a transaction processing module 3360; these elements may be implemented in hardware, firmware, or as software instructions and data encoded on a computer-readable storage medium (e.g., storage medium 3200 or a different storage medium at processing platform 3100).

Friends processing module 3310 provides functionality for interfacing gifts/contributions with a social network, e.g., by managing the actions related to persons or entities to whom funds may be contributed (gifted) or from whom funds may be received. Various types of social networks may be interfaced with in this way. Thus, an existing social network may be tapped to provide a source of possible gift-giving/gift-receiving friends. In this way, Sally's friends on a social network can be enabled to make contributions to her, and vice versa. Membership processor 3320 provides functionality related to membership in a gift giving community. In some embodiments, the friends of an individual (e.g., as determined by friendship processing module 3310) are a subset of the members of the gift giving community. List management processing module 3325 provides functionality related to lists of products for possible gift topics. A list of products available for possible gifting (i.e., for individuals to provide contributions towards such products) may be determined in various ways. For example, a list of specific products may be obtained directly from a retailer. Alternatively, a browser plugin at computer 1100a may obtain, from any e-commerce website, a list of products, e.g., by scraping the website as known in the art. Or, if a user sees a product on a store shelf that she wants as a gift, she may scan the products' barcode such as a quick-response (QR) code (e.g., using her smartphone), and the barcode or information about the product may be transmitted to gift card server 2000. List management processing module 3325 manages list functionality in these various cases and may also, in some embodiments, determine products that are relatively popular (e.g., “trending”), e.g., by observing patterns in social networks or in online publications such as news sites, magazines, journals, newspapers, or web logs (blogs). For example, in some embodiments, the items that are added to user's gift lists, that are recommended to friends, or that are purchased are tracked to populate trending data.

Communications processing module 3330 sends notifications (e.g., email notifications) to people in the gift-giving community (e.g., to notify them that somebody wants a particular gift, or that somebody has made a contribution towards a requested product) and may provide functionality regarding invitations within the gift-giving community. Content engine 3340 provides input to list management processing module 3325 and enables product information to be retrieved from various websites.

Gift processing module 3350 provides functionality pertaining to gift management, group gift management, and event management. As an example of event management, a mother can create a Birthday Party event for son's birthday party, invite friends to participate, and create a list of desired gifts. Gift processing module 3350 enables invitees to respond as to whether they will attend and to contribute towards the desired gifts.

Gift processing module 3350 also maintains and displays gift/list balances (e.g., how much various parties have contributed towards gifts, and how much remains to be contributed to reach the price of the gift) and maintains and displays a transaction history to users.

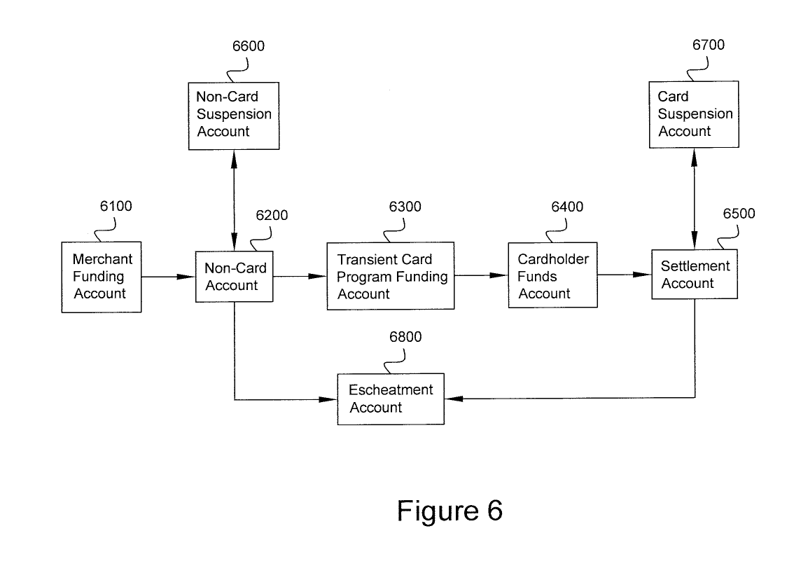

Transaction processor 3360 controls the movement of funds, e.g., by informing financial intermediary 1600 about how to move funds (discussed further below in the context of FIG. 6). Transaction processor 3360 also provides functionality pertaining to gift account management, funds accretion, single use card issuance, account/purse transfers, and fraud detection.

FIG. 6 is a flow diagram of account processing to support dynamic gift cards in accordance with some embodiments. A series of bank accounts may be used and processed to hold funds in compliance with applicable regulations and for ensuring that funds are protected by federal depository insurance. The bank accounts shown in FIG. 6 are “for the benefit of accounts such that only the person for whose benefit the accounts are intended may withdraw funds from the accounts via dynamic card issuance and payments using the card. When a contributing user (e.g., user 5200-1 (Jack) in the example shown in FIG. 5) makes a contribution, the contributed funds enter a merchant funding account 6100 for the benefit of a user (e.g., giftee Sally 5100). The transaction processing module 3360 may control the entry of funds into account 6100. Upon settlement of the transaction (e.g. credit card or debit card transaction in which Jack is making a contribution towards a gift for Sally), the funds move into a non-card account 6200 for the benefit of the receiving user (giftee). Upon Sally's request to utilize funds for a purchase (see FIG. 4), the funds move to a transient account 6300 for the benefit of Sally; this account may be a buffer or “pass-through” account. The loaded funds then move to a cardholder funds account 6400 for the benefit of Sally as the gift card is dynamically created. Upon a merchant settling a purchase transaction, the funds move to a settlement account 6500 for the benefit of Sally prior to being transferred to the merchant's account (not shown).

Unlike with conventional gift card processing techniques, in various embodiments unused virtual gift cards or remainder amounts of a virtual gift card are returned back to the non-card account for the benefit of the user. This is made possible by account 6200, which is a repository for funds to reside and accumulate (e.g., aggregate from various contributing sources) until Sally requests to use the funds (e.g., at the checkout screen in the example of FIG. 4). This approach eliminates latent small denominations remaining on the card (which is a common issue with traditional approaches), inconvenience for consumers, and a profit generator for traditional gift card programs.

Additional accounts for the benefit of the user exist for situations when fund access is suspended, e.g., due to suspected fraudulent card use. These accounts 6600, 6700 are related to the non-card account 6200 and the cardholder funds account 6400. Funds move into the appropriate suspension account at the beginning of a fraud investigation and are returned upon successful resolution of the investigation.

An escheatment account 6800 for the benefit of the user (e.g., Sally) is also provided for compliance with individual state laws concerning inactive accounts and abandoned funds.

With the series of accounts shown in FIG. 6, security is enhanced, as there is no direct way for a malicious party to extract funds from account 6200 (into which various people may have contributed funds), for example. Rather, various subsequent account processing occurs in a controlled manner to ensure that the funds are provided to the intended party in a secure manner. The accounts shown in FIG. 6 are all “for the benefit of (FBO) accounts. Consequently, an operating/administrating company (that operates or controls the gift-related processing) cannot access the funds itself, and the funds are FDIC insured.

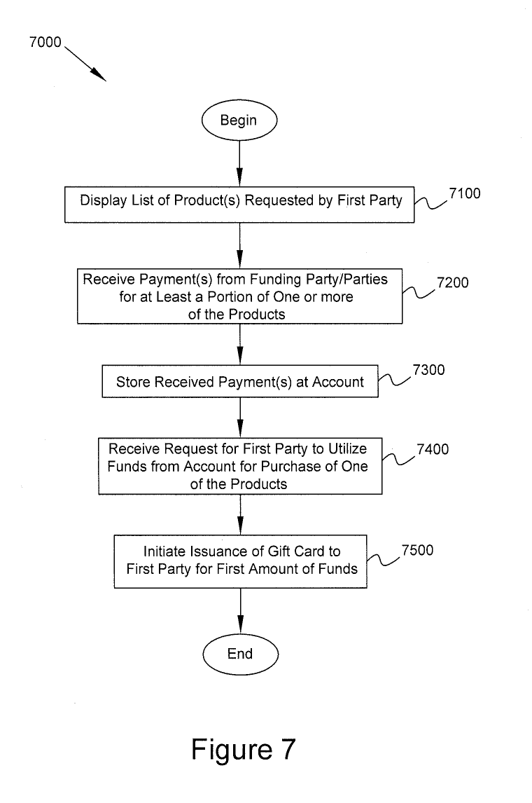

FIG. 7 is a flow diagram of a process 7000 in accordance with some embodiments. After process 7000 begins, a list of one or more products requested by a first party (e.g., Sally) is displayed (block 7100). At least one payment is received (block 7200) from at least one funding party (e.g., Jack) for at least a portion of one or more of the products, wherein the payment is on behalf of the first party. The received payment(s) is stored (block 7300) at an account (e.g., account 6200). A request is received (block 7400) for the first party to utilize funds from the account for a purchase of one of the products. A virtual or physical gift card is issued (block 7500) to the first party for a first amount of funds.

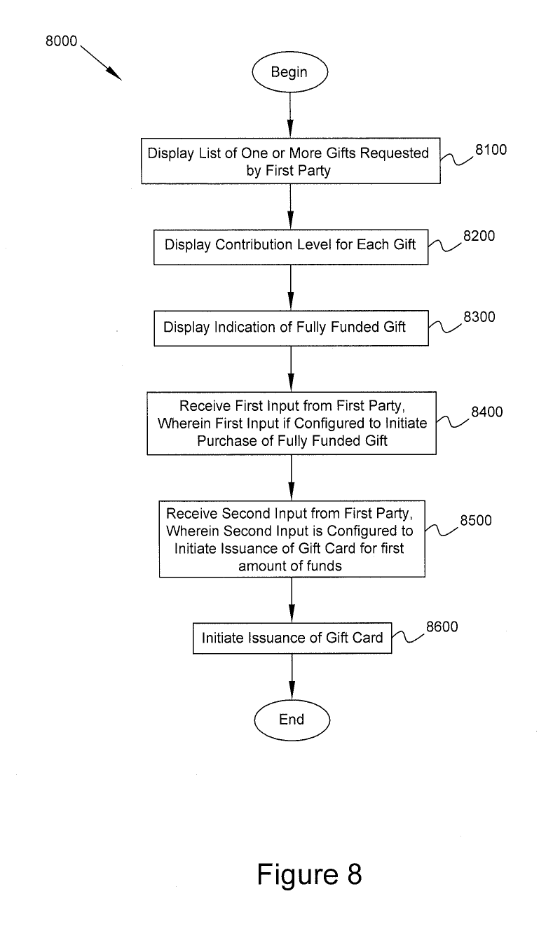

FIG. 8 is a flow diagram of a process 8000 in accordance with some embodiments. After process 8000 begins, a list of one or more gifts requested by a first party is displayed (block 8100). A contribution level for each gift, based on one or more contributions previously made by one or more funding parties towards said gift, is displayed (block 8200). An indication of a fully funded gift among said one or more gifts is displayed (block 8300). A first input is received from the first party (block 8400). The first input is configured to initiate a purchase of the fully funded gift. A second input is received from the first party (block 8500). The second input is configured to initiate issuance of a gift card to the first party for a first amount of funds. Issuance of the gift card to the first party is initiated for the first amount of funds (block 8600).

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the current disclosure is not intended to be limited to the embodiments shown herein, but is to be accorded the widest scope consistent with the principles and novel features disclosed herein.

What is claimed is:

1. A computer-implemented method of gift card processing, said method comprising:
displaying a first list of one or more products requested by a first party;
receiving at least one payment from at least one funding party for at least a portion of one or more of the products;
storing the received payment at a first account;
receiving a first request for the first party to utilize funds from the first account for a purchase of one of the products; and
initiating an issuance of a first gift card to the first party for a first amount of funds.

2. The method of claim 1, wherein the first amount is an amount specified by the first party.

3. The method of claim 2, wherein the amount specified by the first party is equal to a remaining balance for the purchase of said one product by the first party.

4. The method of claim 1, further comprising computing the first amount as the lesser of:
a remaining balance for the purchase of said one product by the first party; and
a second, predetermined, amount of funds.

5. The method of claim 1, wherein the first gift card is a virtual gift card.

6. The method of claim 5, wherein the virtual gift card is an open loop virtual gift card.

7. The method of claim 5, further comprising issuing a second gift card to the first party for the predetermined amount of funds, wherein the second gift card is a physical gift card.

8. The method of claim 1, wherein the first gift card is a physical gift card.

9. The method of claim 8, wherein the physical gift card is a non-reloadable physical gift card.

10. The method of claim 1, further comprising:
automatically searching one or more websites of one more merchants to generate a second list of products offered by the one or more merchants;
displaying the second list to the first party;
receiving an input from the first party specifying one or more products from the second list requested by the first party; and
generating the first list based on the received input.

11. The method of claim 1, further comprising:
receiving a barcode input from the first party, said barcode input corresponding to a product selected by the first party;
wherein at least one of the products in the first list is said product selected by the first party.

12. The method of claim 1, wherein said at least one funding party includes the first party.

13. The method of claim 1, further comprising:
detecting a period of inactivity of the first account; and
transferring funds from the first account to a second account based on the detected period of inactivity, wherein the second account is an escheatment account.

14. The method of claim 1, further comprising:
transferring funds from the first account to a second account when a predetermined condition is satisfied, wherein the second account is a suspension account; and
freezing the first account until a suspension is lifted.

15. The method of claim 1, further comprising:
maintaining the first gift card in an active state until a predetermined expiration time, wherein the first party is enabled to use the first gift card in said active state for the purchase of any one or more of the products in the first list subject to a remaining balance of the first gift card; and
at or after the expiration time, returning the remaining balance of the first gift card to the first account.

16. The method of claim 15, further comprising:
after the expiration time, receiving a second request for the first party to utilize funds from the first account for a purchase of one of the products in the first list; and
initiating an issuance of a second gift card to the first party responsive to the second request.

17. A computer-readable storage medium encoded with data and instructions, that when executed by a computing device, causes the computing device to:
display a first list of one or more products requested by a first party;
receive at least one payment from at least one funding party for at least a portion of one or more of the products, wherein the payment is on behalf of the first party;
store the received payment at a first account;
receive a request for the first party to utilize funds from the first account for a purchase of one of the products; and
initiate an issuance of a first gift card to the first party for a first amount of funds, wherein the first gift card is one of a virtual gift card and a physical gift card.

18. The computer-readable storage medium of claim 17, wherein the first gift card is a virtual gift card.

19. The computer-readable storage medium of claim 17, wherein the first amount is an amount specified by the first party and is equal to a remaining balance for the purchase of said one product by the first party.

20. The computer-readable storage medium of claim 17, wherein the first amount is the lesser of:
a remaining balance for the purchase of said one product by the first party; and
a second, predetermined, amount of funds.

21. A computer-implemented method of gift card processing, said method comprising:
displaying a list of one or more gifts requested by a first party;
displaying a contribution level for each gift based on one or more contributions previously made by one or more funding parties towards said gift;
displaying an indication of a fully funded gift among said one or more gifts;
receiving a first input from the first party, said first input configured to initiate a purchase of said fully funded gift;
receiving a second input from the first party, said second input configured to initiate issuance of a gift card to the first party for a first amount of funds; and
initiating issuance of the gift card to the first party for the first amount of funds.

22. The method of claim 21, further comprising updating the list to indicate that said fully funded gift has been purchased by the first party.

23. The method of claim 21, further comprising receiving a third input from the first party, the third input specifying the first amount of funds.

24. The method of claim 21, further comprising computing the first amount as the lesser of:
a remaining balance for the purchase of said one product by the first party; and
a second, predetermined, amount of funds.
